(19) United States
(12) Patent Application Publication
(10) Pub. No.: US 2024/0295625 A1
(43) Pub. Date: Sep. 5, 2024

(54) METHODS AND APPARATUS FOR TRAINING BASED POSITIONING IN WIRELESS COMMUNICATION SYSTEMS

(71) Applicant: Interdigital Patent Holdings, Inc., Wilmington, DE (US)

(72) Inventors: Fumihiro Hasegawa, Westmount (CA); Jaya Rao, Montreal (CA); Yugeswar Deenoo Narayanan Thangaraj, Chalfont, PA (US); Aata El Hamss, Laval (CA); Tuong Hoang, Montreal (CA); Paul Marinier, Brossard (CA); Moon IL Lee, Melville, NY (US); Ghyslain Pelletier, Montréal (CA)

(21) Appl. No.: 18/271,605

(22) PCT Filed: Jan. 12, 2022
(86) PCT No.: PCT/US2022/012176

§ 371 Date: Jul. 10, 2023

Related U.S. Application Data
(60) Provisional application No. 63/228,946, filed on Aug. 3, 2021.
(60) Provisional application No. 63/136,484, filed on Jan. 12, 2021.

(51) Int. Cl. G01S 5/02

(52) U.S. Cl. CPC G01S 5/0236; G01S 5/0268

(57) ABSTRACT

The disclosure pertains to methods and apparatus for using artificial intelligence and machine learning for positioning of nodes (e.g., wireless transmit/receive units (WTRUs)) in wireless communications. In an example, a method implemented by a WTRU for wireless communications includes receiving configuration information indicating a plurality of positioning methods and a threshold, determining a respective weight for each of the plurality of positioning methods, and sending the respective weights for the plurality of positioning methods based on determining that at least one of the respective weights is greater than the threshold and/or after a preconfigured time period.

### CROSS-REFERENCE TO RELATED APPLICATIONS

This application claims priority to and the benefit of U.S. Provisional Application No. 63/136,484 filed in the U.S. Patent and Trademark Office on Jan. 12, 2021, and U.S. Provisional Application No. 63/228,946 filed in the U.S. Patent and Trademark Office on Aug. 3, 2021, the entire contents of each of which being incorporated herein by reference as if fully set forth below in their entirety and for all applicable purposes.

### SUMMARY

Embodiments disclosed herein generally relate to wireless communication networks. For example, one or more embodiments disclosed herein are related to methods and apparatus for using artificial intelligence and machine learning for positioning of nodes, e.g., wireless transmit/receive units (WTRUs) in wireless communication networks.

In one embodiment, a method implemented by a wireless transmit/receive unit (WTRU) for wireless communications includes receiving configuration information indicating a plurality of positioning methods and a threshold, determining a respective weight for each of the plurality of positioning methods, and sending the respective weights for the plurality of positioning methods based on determining that at least one of the respective weights is greater than the threshold and/or after a preconfigured time period.

In one embodiment, the WTRU comprising a processor, a transmitter, a receiver, and/or memory may be configured to implement the method disclosed herein. For example, the WTRU may be configured to receive configuration information indicating a plurality of positioning methods and a threshold, determine a respective weight for each of the plurality of positioning methods, and send the respective weights for the plurality of positioning methods based on determining that at least one of the respective weights is greater than the threshold and/or after a preconfigured time period.

### BACKGROUND

In Rel. 16 (3GPP), downlink, uplink, and downlink and uplink positioning methods are specified.

In the downlink positioning methods, Positioning Reference Signals (PRSs) are sent from multiple Transmission/Reception Points (TRPs) of a wireless communication network to the WTRU. The WTRU will observe multiple reference signals and measure time difference of arrival between a pair of PRSs. Then, the WTRU returns measured Reference Signal Time Difference (RSTD) to the Location Management Function (LMF). In addition, the WTRU can return measured Reference Signal Received Power (RSRP) for each PRS. Based on the returned measurements, the LMF conducts positioning of the WTRU. Alternatively, the WTRU can report RSRP for downlink (DL) angle-based positioning methods.

In the uplink positioning methods, the WTRU sends a Sounding Reference Signal (SRS) for positioning, configured by RRC (Radio Resource Control), to Reception Points (RPs) or TRPs. For timing-based methods, TRP measures Relative Time of Arrival (RTOA) for received SRS signals and reports measured values to the LMF. The WTRU can report RSRP for SRS. In angle-based uplink positioning methods, an RP or TRP will measure angles of arrival and report it to the LMF.

In the uplink and downlink positioning method, a WTRU measures Rx−Tx time difference between a received PRS and a transmitted SRS. The Rx−Tx time difference is reported to the LMF. The WTRU can also report measured RSRP for PRS and, the TRP computes the Rx−Tx difference between the received SRS and the transmitted PRS.

A “DL positioning method” may refer to any positioning method that requires downlink reference signals, such as PRS. In such positioning techniques, the WTRU may receive multiple reference signals from TP and measures DL RSTD and/or RSRP. Examples of DL positioning methods include DL-AoD or DL-TDOA positioning.

A “UL positioning method” may refer to any positioning technique that requires uplink reference signals, such as SRS for positioning. In such techniques, the WTRU may transmit SRS to multiple RPs or TRPs, and the RPs or TRPs measure the UL RTOA and/or RSRP. Examples of UL positioning methods include UL-TDOA or UL-AoA positioning.

A “DL & UL positioning method” may refer to any positioning method that requires both uplink and downlink reference signals for positioning. In one example, a WTRU transmits SRS to multiple TRPs and a gNB measures the Rx−Tx time difference. The gNB can measure RSRP for the received SRS. The WTRU measures Rx−Tx time difference for PRSs transmitted from multiple TRPs. The WTRU can measure RSRP for the received PRS. The Rx−TX difference, and possibly RSRP measured at the WTRU and the gNB, are used to compute round trip time. Here, Rx and Tx difference refers to the difference between arrival time of the reference signal transmitted by the TRP and transmission time of the reference signal transmitted from the WTRU. An example of DL & UL positioning method is multi-RTT (Round Trip Time) positioning.

DL-based positioning (and possibly DL&UL positioning) is either WTRU-based (i.e., the WTRU conducts positioning) or WTRU-assisted (the network conducts the positioning operations using with measurement reports sent from the WTRU).

In this disclosure, the term “network” is inclusive of AMF, LMF, and NG-RAN.

### BRIEF DESCRIPTION OF THE DRAWINGS

A more detailed understanding may be had from the detailed description below, given by way of example in conjunction with the drawings appended hereto. Figures in such drawings, like the detailed description, are exemplary. As such, the Figures and the detailed description are not to be considered limiting, and other equally effective examples are possible and likely. Furthermore, like reference numerals (“ref.”) in the Figures (“FIGS.”) indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a diagram of an exemplary neural network;

FIG. 3 is diagram illustrating exemplary input, actual output, and intended output of a machine learning model in accordance with a first embodiment;

FIG. 4 is a diagram illustrating exemplary input, actual output, and intended output of a machine learning model in accordance with a second embodiment;

FIG. 5 is a signal flow diagram illustrating signal flow for a WTRU-initiated training procedure for positioning in accordance with an embodiment; and

FIG. 6 is a diagram illustrating an example of a training-based positioning scheme for wireless communications, in accordance with one or more embodiments.

### DETAILED DESCRIPTION

### 1 Introduction

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein.

### 2 Example Networks for Implementations

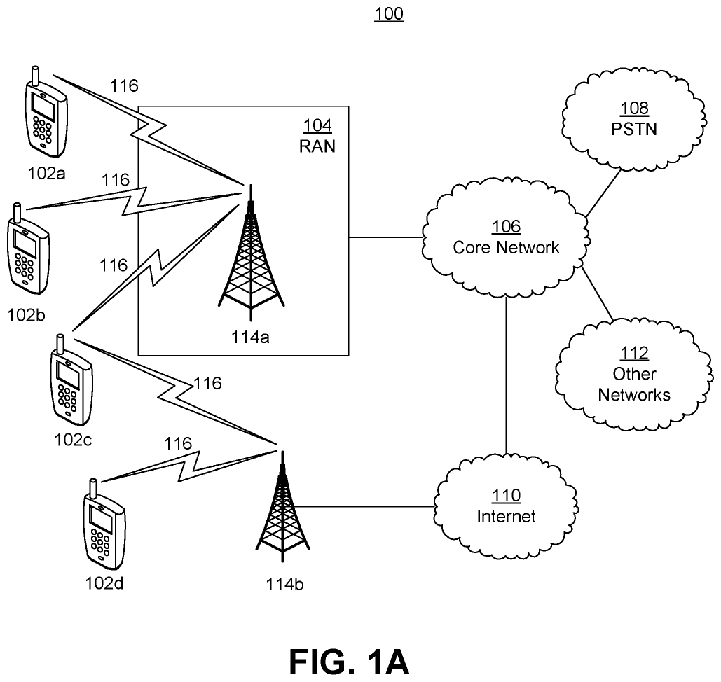

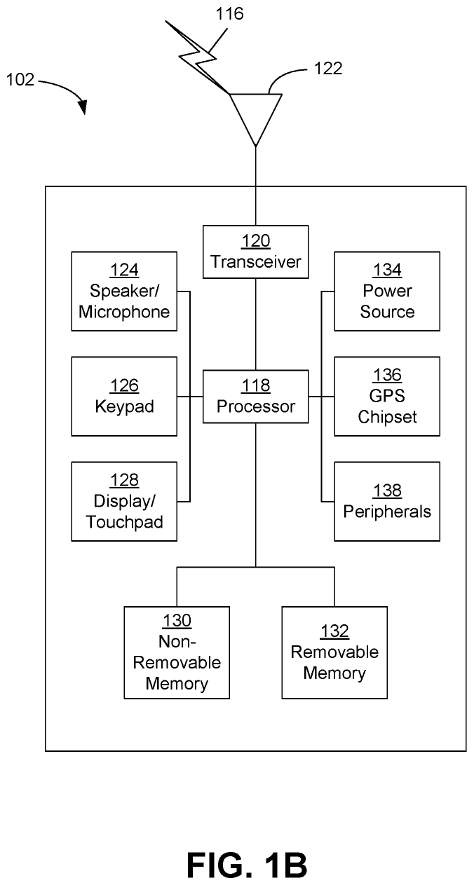

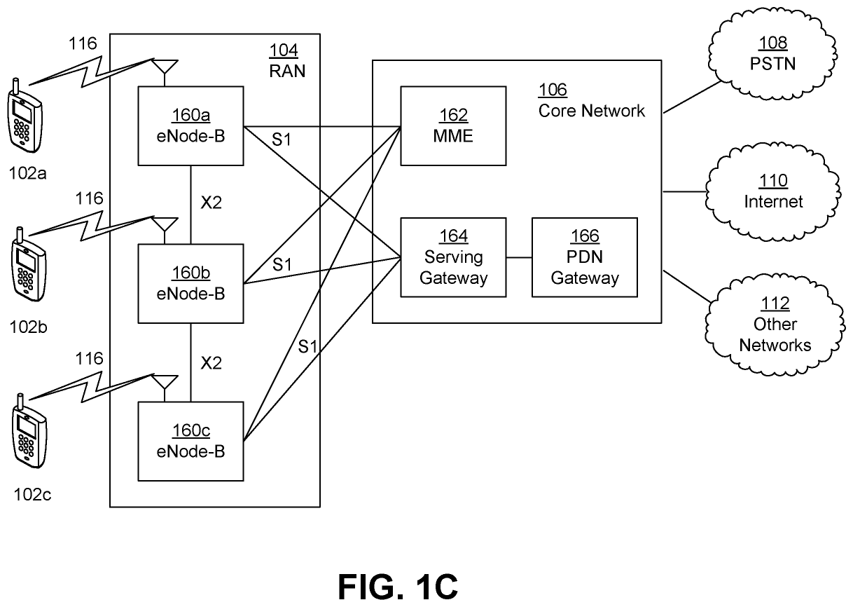

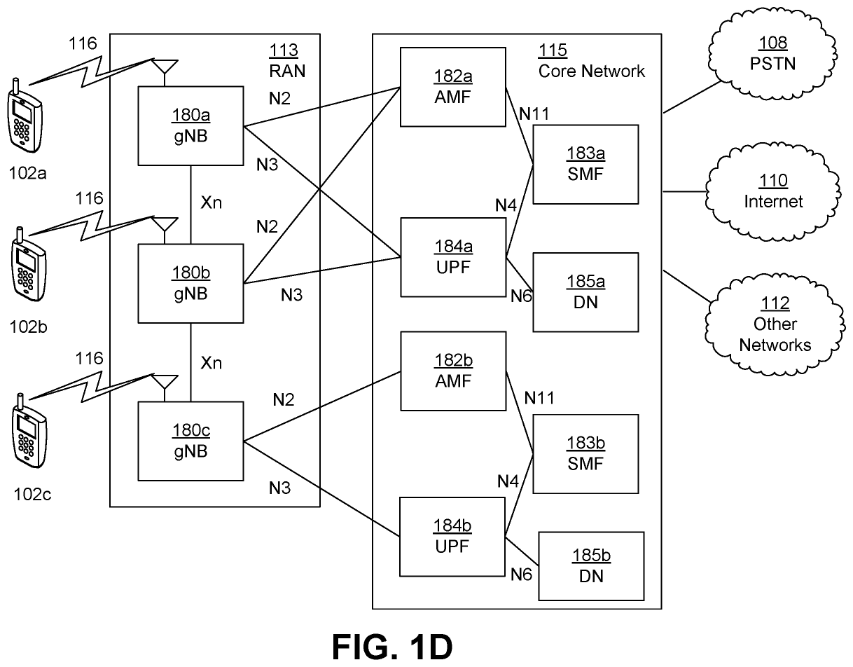

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 180b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of Non-Access Stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### 3 Artificial Intelligence

Artificial Intelligence (AI) may be broadly defined as behavior exhibited by machines that mimics cognitive functions to sense, reason, adapt and act.

### 3.1 Machine Learning (ML)

### General Principles of ML

Machine learning may refer to types of algorithms that solve a problem based on learning through experience (data), without explicitly being programmed (configuring a set of rules). Machine learning can be considered a subset of AI. Different machine learning paradigms may be envisioned based on the nature of data or feedback available to the learning algorithm. For example, a supervised learning approach may involve learning a function that maps input to an output based on a labeled training example, wherein each training example may be a pair consisting of input and the corresponding output. For example, an unsupervised learning approach may involve detecting patterns in the data with no pre-existing labels. For example, a reinforcement learning approach may involve performing a sequence of actions in an environment to maximize the cumulative reward. In some solutions, it is possible to apply machine learning algorithms using a combination or interpolation of the above-mentioned approaches. For example, a semi-supervised learning approach may use a combination of a small amount of labeled data with a large amount of unlabeled data during training. In this regard, semi-supervised learning falls between unsupervised learning (with no labeled training data) and supervised learning (with only labeled training data).

### 3.2 Neural Networks

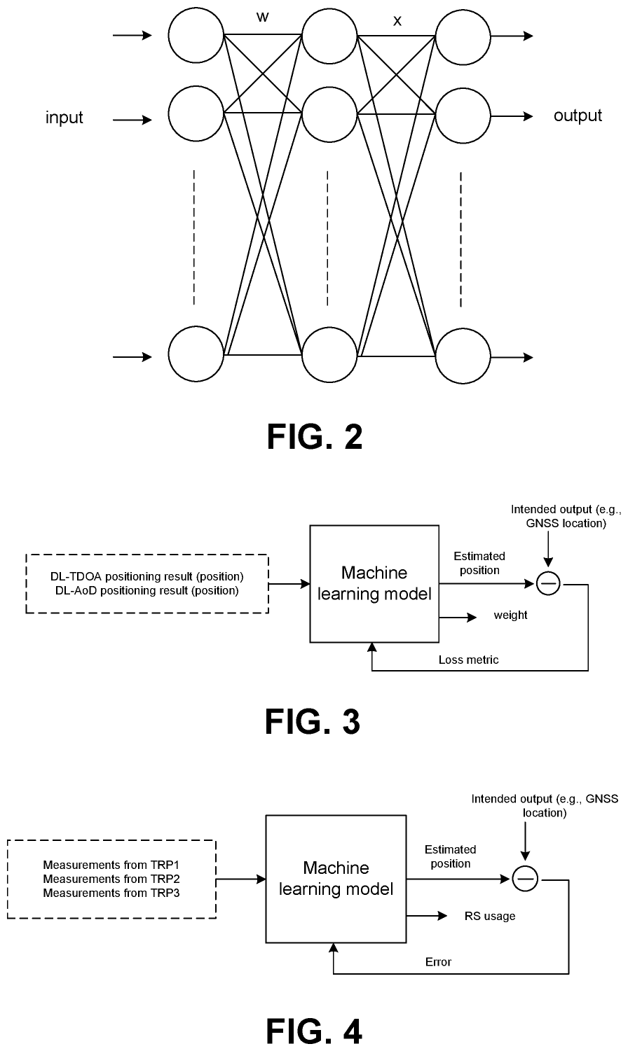

One example of a neural network is shown in FIG. 2. The objective of training is to apply an input and adjust weights, indicated as w and x in the figure, such that the output from the neural network approaches the desired target values associated with the input values. In the example, the neural network consists of 2 layers. During the training, for a given input, the difference between the output and the desired values are computed and the difference is used to update the weights in the neural network. If a large difference between the outputs and the desired values is observed, large changes in weights are expected, while small difference will lead to small changes in weights.

For example, for positioning in a wireless communication network, the input may be reference signal parameters and the output may be an estimated position. The desired value can be location information acquired by Global Navigation Satellite System (GNSS) with high accuracy.

Once the neural network completes its training, it can be applied for in a communication network for positioning of WTRUs by feeding it input data and using the output as the expected outcome for the associated input (e.g., estimated position or location of the WTRU).

Thus, for training a neural network, it is important to identify the following
Input for the neural network
Expected output associated with the input
Actual output from the neural network (against which the target values are compared)

As an example, a neural network model can be characterized by the following parameters:
Number of weights
Number of layers in a neural network

### 3.3 Deep Learning (DL)

Deep learning refers to a class of machine learning algorithms that employ artificial neural networks (specifically Deep Neural Networks (DNNs)), which were loosely inspired by biological systems. DNNs are a special class of machine learning models inspired by the functioning of the human brain, wherein the input is linearly transformed and passed through a non-linear activation function multiple times. DNNs typically comprise multiple layers where each layer comprises linear transformation and a given non-linear activation functions. DNNs can be trained using training data via a back-propagation algorithm. Recently, DNNs have shown state-of-the-art performance in a variety of domains, e.g., speech, vision, natural language, etc., and for various machine learning settings (e.g., supervised, un-supervised, and semi-supervised). An AI component may refer to realization of behaviors and/or conformance to requirements by learning based on data, without explicit configuration of a sequence of steps of actions. Such an AI component may enable the learning complex behaviors which might be difficult to specify and/or implement using legacy methods.

In addition, “events” or “occasions” may be used interchangeably in this disclosure.

### 4 Perspectives on Current Techniques for Positioning in Wireless Communication Systems

3GPP Rel. 16 does not use a combination of multiple positioning methods for determining the locations of WTRUs and long-term statistics are not returned to the positioning server. Accuracy and latency for positioning are important performance metrics.

### Accuracy Perspective

The current positioning framework in 3GPP only allows a method to use a particular set of measurements (e.g., Downlink-Angle of Departure (DL-AoD) uses angle-based measurements, Downlink-Time Difference of Arrival (DL-TDOA) uses timing-based measurements). The accuracy of a positioning algorithm is limited by the measurements that are available.

For on-demand Reference Signal (RS), only a limited number of parameters can be reconfigured.

Non-3GPP positioning may be available by GNSS and/or IEEE/sensor-based positioning, but they may not be available all the time.

### Latency Perspective

LPP message exchange between a WTRU and an LMF (Location Management Function) consumes large amount of time, possibly causing large latency. Thus, LTE Positioning Protocol (LPP) transfer should be minimized.

Changes in environment (e.g., moving objects that block the path between a gNB and a WTRU) may require reconfiguration of PRS parameters (and also change the TRPs used for PRS transmission), which may cause further delay in positioning procedure

Offloading computation to WTRU instead of centralized computation at location server may reduce latency.

### 5 Uses of AI for Positioning Functionality in Wireless Communications

Through deep learning, AI can expose new sets of measurements that cannot be exploited by the set of “one-shot” measurements (e.g., RSRP, time of arrival, etc.) currently used in 3GPP networks.

A versatile algorithm (via AI) can be implemented to accurately locate WTRUs in a wireless communication network.

A WTRU may be equipped with an autonomous positioning system configured to make intelligent judgements in selecting RS/system parameters that will provide more accurate positioning measurements.

### 5.1 Definition of a Function of a Machine Learning Model, Measurement or Training Status Reporting

### General Description of Training

A WTRU may be configured to train a machine learning model according to a preconfigured set of inputs and preconfigured set of outputs. The set of inputs and outputs may be based on one or more of the following: WTRU measurements, sensor data, imaging/video data, positioning information (such as GNSS), inputs from the network (including data and/or assistance information), outputs of positioning methods, etc.

### Training

A WTRU may implement any machine learning model as long as a preconfigured training criterion is met. For example, the training criterion may be expressed as a function of a loss metric and a preconfigured threshold. A loss metric may express the difference between an intended output and the actual output of the machine learning model, given a particular input. The output from the machine learning model may include inference information, such as weights for the inputs. Hereafter, “inference information” and “inference data” may be used interchangeably. Furthermore, “inference value” may be used hereafter to refer to a single piece of inference data, such as a weight assigned to a single input or input type.

A machine learning model may be assumed to be successfully trained when a preconfigured training criterion is satisfied. For example, a training criterion may be that the loss metric is lower than a preconfigured threshold. In one solution, the WTRU may receive at least one configuration aspect of the training criterion from the network.

Some of the examples of input, output, intended output, and inference information for a machine learning model are described below.

### Example 1

Input: Position estimates from multiple methods
Intended output: position obtained from GNSS
Actual output: estimated position
inference information: weights for the positioning estimates for multiple methods

### Example 2

Input: Measurements obtained from PRS transmitted from different TRPs
Intended output: position obtained from GNSS
Actual output: estimated position
Inference information: weights for the measurements corresponding to different TRPs

### Example 3

Input: Reference signal parameters
Intended output: observed measurements,
Actual output: estimated measurements
Inference information: e.g., indication of trust for the reference signals used for positioning, weights for the reference signals used for positioning, frequency, or duration the reference signals used for positioning

FIG. 3 is a diagram of a first exemplary machine learning model for a combination of two different positioning methods (e.g., DL-TDOA and angle-based DL-AoD) illustrating input, actual output (estimated position), and intended output (GNSS location) during training. In this embodiment, the inputs are estimated positions using two different positioning methods, such as DL-TDOA (Downlink Time Difference of Arrival) and DL-AoD (Downlink Angle of Departure).

FIG. 4 is a diagram of another exemplary machine learning model that takes in RS parameters and measurements from multiple TRPs and outputs estimated positions and RS usage (which may be tied to measurements, i.e., RSRP from TRPs). In this example, inputs of the machine learning model are measurements obtained from PRS transmitted from multiple TRPs, actual outputs are estimated position, and intended outputs are GNSS locations.

Weights for interference information could indicate a measure of trust for inputs. For example, in the example illustrated in FIG. 3, if the weights are adjusted so that they add up to 1, the weights for DL-AoD and DL-TDOA may be 0.8 and 0.2, respectively. This means that during training, the angle-based positioning method, DL-AoD, is more reliable than DL-TDOA. Such inference information may be sent to the network during or after training so that the network can configure positioning reference signals or TRPs from which positioning reference signals are transmitted such that the parameters are more optimal for the angle-based positioning method.

Alternatively, the WTRU or network may use inference values to derive the position of the WTRU. An inference value may be a weight (e.g., a number) that may be associated with the location/position estimate obtained from a positioning method or measurements obtained from PRS, or PRS, for example. The weight may be used to derive a location/position estimate or it may be used by the WTRU or network (e.g., gNB, LMF) to determine a level of certainty or confidence in the accuracy of the measurement or location estimate. Using the aforementioned example, if the WTRU obtains two position estimates from DL-AoD and DL-TDOA, pos1 and pos2, respectively, the WTRU may obtain the new position estimate by using the weighted average. 0.8*pos1+0.2*pos2 where summation of the weights (0.8 and 0.2 in the example) is equal to one. During or after training the machine learning model, the WTRU may indicate to the network that the weighted average is used to obtain the location/position estimate and send associated inference values.

In another example, the WTRU may be located along a straight line, where “0” is the center point of the line. The DL-TDOA method may indicate that the WTRU is located at +1 m (1 meter to the right of the center point). The DL-AoD method may indicate that the WTRU is located at −0.5 m (0.5 meter to the left of the center point). From the machine learning model, the WTRU obtains Inference values which are 0.8 and 0.2 for DL-TDOA and DO-AoD, respectively. Thus the estimated position will be 0.8*1 m+0.2*(−0.5 m)=0.7 m from the center of the line.

The WTRU may obtain inference values through training the machine learning model. For example, if there is a set of training data characterized by location estimate from DL-TDOA positioning method, location estimate from DL-AoD positioning method and GNSS position (herein expressed as (x1, x2, y) where x1, x2, and y are the location estimate obtained by DL-TDOA, the location estimate obtained by DL-AoD, and the reference point (e.g., obtained via GNSS), respectively), the WTRU may obtain the following training data set for the machine learning model:
x1=(0.5 m, −0.1 m, 0 m)
x2=(0.6 m, 0.3 m, 0.1 m)
y=(1.5 m, −0.3 m, −0.1 m)

The WTRU may present the parameter to the machine learning model, along with a desired number of weights and function (e.g., y=w1*x1+w2*x2, where w1 and w2 are weights/inference values). The WTRU may receive a function and a number of weights from the network, along with the machine learning model parameters, for example. The WTRU may determine the inference values, w1 and w2, which yield the minimum error in the training data above with the error defined by e=y−(w1*x1+w2*x2) and x1, x2 and y are location estimates from DL-TDOA, DL-AoD and GNSS, respectively. The WTRU may obtain the weights by iterative method to minimize the error or least square minimization method, for example. As the result of training, the WTRU will be able to obtain inference values, w1 and w2, from the machine learning model.

### Reporting Status During Training

In an embodiment, the WTRU may be configured to report the status of a machine learning model training to the network (a “training status report”). Such training status reporting may be periodic and/or based on preconfigured events or occasions. For example, the WTRU may be configured to transmit a training status report when the loss function changes by a preconfigured value. For example, the WTRU may be configured to transmit a training status report every N occasions, wherein an “occasion” refers to any event at which the WTRU transmits a measurement report, a training status report, or other uplink data. The value of N may be configured from the LMF in the LPP message. An occasion may be a configured or dynamic uplink grant, or a specified period of time during which the WTRU is configured to send the measurement report.

In another embodiment, the WTRU may be configured to send a semi-static report whose occasion may depend on a (pre)configured condition for reporting. The condition may be configured by RRC or LMF. For example, the WTRU may be configured to transmit a measurement or training status report when the value of the loss function is above or below a preconfigured threshold. In some solutions, the WTRU may be configured to report a statistic and/or information derived from learned parameters of the machine learning model.

Once the preconfigured training criterion is met or during the training, the WTRU may report to the network at least one of the following quantities as inference information:
long-term PRS usage information, e.g., frequency or duration PRS is used for positioning
a weight indicating usefulness for positioning methods
variation in accuracy over a predefined time window, e.g., standard deviation in positioning accuracy measured by difference between intended output and output from the machine learning model

### Application After Training

A WTRU may be configured to apply a pretrained machine learning model to process sets of inputs and produce an output as a function of the inputs. The output may be an inference, position/location estimate, and/or prediction related to positioning procedure (such as which positioning procedure to use in a given instance or combination of position estimates available from multiple positioning methods). A WTRU may be configured to perform one or more actions based on the output of the machine learning model.

Reported inference information can be useful for the network in finding an optimum resource utilization of RS configuration or TRP.

### WTRU Uses ML/AI Methods for Positioning for Supporting Extended Reality (XR) Applications

In one solution, the WTRU may determine/estimate the location information based on reference observations and a machine learning approach/method, which may be trained at least in part with training data associated with XR. For supporting XR applications/services, the WTRU may determine the location information of itself and/or other real/virtual objects detectable in the WTRU environment, possibly for appropriately placing/overlaying the objects in the user's viewport relative to the WTRU's location. In an example, the WTRU may receive training data associated with XR comprising one or more of the following:
Mapping between one or more input features and one or more output labels
Mapping between one or more input features and measurements/observations made by the WTRU
Pre-trained model (e.g., hyperparameters and weights associated with a neural network or machine learning model)

The elements of the XR training data received by the WTRU may comprise one or more of the following:
Inputs (Features):
   Image frames or a video feed of the WTRU environment (e.g., geo-anchors or landmarks) that may be detected/captured with a camera
   Real objects, which may be detected with a camera or other sensors in the WTRU (e.g., lidar, RF reader, proximity sensor)
   Virtual objects/content (e.g., 3D objects, avatars), which may be visible in a user's viewport
   Inertial data from sensors (e.g., accelerometer, gyroscope) associated with the WTRU
Outputs (Labels):
   Geo-location/tags (e.g., location information or geographic coordinates of the objects detectable by the WTRU)
   Location information and/or weights associated with positioning anchors/waypoints (applicable for relative positioning and resizing). Positioning anchors may include
      (i) landmarks directly/indirectly visible to the WTRU,
      (ii) TRPs/gNBs whose associated RS/beams may be measured by the WTRU
   Temporal information (e.g., timestamps associated with stationary/moving objects)
   3 DoF/6 DoF (Degree of Freedom) orientation of the WTRU (translational directions and/or rotational directions)
   Directional and/or movement attributes (e.g., linear/angular velocity, acceleration) of the WTRU and/or other tracked objects
Observations (e.g., measurements):
   Reference positioning information (e.g., determined from measurements made on RAT-dependent and/or RAT-independent signals)
   Sensor information

Upon completion of training, the WTRU may apply the trained model for predicting and/or making inferences of the location information of the WTRU and/or other objects detectable/visible to the WTRU.

### 5.2 Training Procedure

### 5.2.1 Training Procedure: Online Training Using a Reference

### WTRU Updates the NN Using the Reference Point Obtained From GNSS

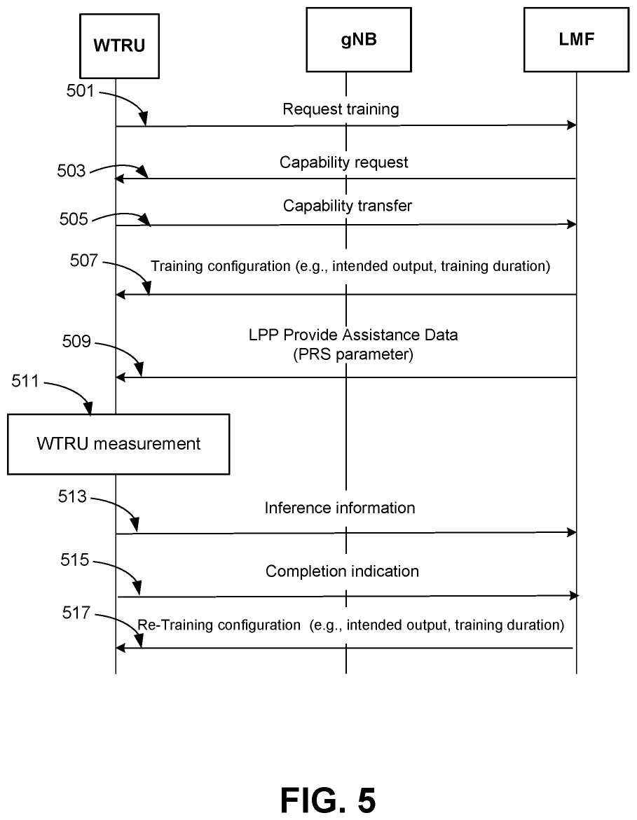

A reference point is defined as a location estimate of the WTRU. The WTRU will use the reference point during training of the machine learning model where the reference point serves as the “actual location of the WTRU”. Therefore, the WTRU needs to obtain the location estimate from a reliable source, e.g., GNSS when line of sight is available between the WTRU and GNSS satellites. FIG. 5 is a signal flow diagram illustrating an example of a WTRU initiated training procedure for positioning and can be summarized as follows:
1. The WTRU sends a request for training to the network (501)
   a. The request may include available reference source(s), where the reference source is the location estimator from which the WTRU can obtain an accurate position e.g., GNSS or reference station
2. The network requests WTRU capability information from the WTRU (503)
3. The WTRU sends the WTRU capability information to the network (505)
4. The WTRU is configured with the function of the machine learning model and training type and/or training configurations (e.g., online/offline, duration for training, definitions of input, expected output and actual output of a machine learning model) and default reference source for training where the reference source is used to compute the loss metric during the training (507).
5. The WTRU receives a PRS configuration, e.g., in LPP Provide Assistance Data (509)
   If offline training is configured, the WTRU may receive training data
6. The WTRU performs positioning and determines the loss metric between estimated position and reference source (511)
   a. If the loss metric is larger than the threshold, the WTRU may request from the network a new reference source or new configurations for RS for training for LMF and the LMF may provide assistance data for the new reference source via LPP (not illustrated).
7. If the WTRU is configured by the network, the WTRU may report the loss metric and/or inference data to the network in periodic or semi-persistent or aperiodic occasions (513).
8. If the criteria for completion of training is satisfied (e.g., loss metric is lower than the preconfigured threshold), the WTRU may transmit an indication to the network informing the network that the training is complete (515). For example, the following explicit or implicit indication may be used to indicate completion of training.
   Explicit: The WTRU sends a flag to the network
   Implicit: The WTRU sends the result of the training (e.g., loss metric data, inference information) to the network.
9. If the training could not be completed since the WTRU could not meet the training criterion, the network may send a new configuration for re-training (517).

The completion of training may be based on preconfigured training criteria. Such training criteria may include at least one of the following:
The loss metric is lower than a preconfigured threshold
The preconfigured training duration expired
The loss metric is lower than a preconfigured threshold for a preconfigured duration

The inference data may be used by the network for reconfiguration of positioning parameters. Examples of the inference data include:
1. Usage of reference signals or TRPs expressed by weights
2. Usage of positioning methods

Inference data such as the weights described above may include percentages, integers, fractions, for example. These values may indicate reliability or frequencies that were used during training. The weights may add up to 1. For example, if the WTRU receives 4 PRSs during training, the WTRU may indicate to the network that 0.1, 0.2, 0.3 and 0.4 are the weights computed for each PRS. The WTRU may indicate 0 for any reference signal the WTRU did not use during training.

The WTRU may report usage of positioning methods. For example, the WTRU may implement multiple positioning methods. Inference data in this case may be weights placed on the position estimate from each positioning method.

In WTRU-initiated positioning (e.g., WTRU-based Mobile Originated-Location Request (MO-LR) and/or WTRU-assisted MO-LR), the request for WTRU location information may originate from higher layers in the WTRU (e.g. a Location Service (LCS) client) and sent to the network (e.g., the RAN or LMF). The positioning request may also include information related to positioning QoS (e.g., accuracy, latency, integrity). The WTRU may piggyback the capability information with the positioning request or may receive the request for capability information from the network, including support for ML/AI methods for positioning in the WTRU. Upon sending the capability information to the network, the WTRU may receive assistance information (e.g., via LPP/RRC) including the selected positioning/training mode along with the configuration associated with training for supporting ML/AI for positioning.
In the case when WTRU-based training (offline/online) is selected, the WTRU may receive the ML/AI configuration, comprising training data and/or model parameters, for performing positioning related training at the WTRU. Upon completion of training (e.g., error, difference, or loss metric between the predicted and actual positions is below a threshold), the WTRU may send the training status report to the network based on a reporting configuration (e.g., periodic and/or event triggered).
In the case when WTRU-assisted training is selected, the WTRU may receive a configuration for supporting training, comprising the set of measurements (e.g., possibly new measurements related to ML/AL for positioning), observations, and resource configuration, for example. Upon completion of measurements over a configured duration, the WTRU may then send the measurement report based on reporting configuration for assisting with the training at the network.

In another example of WTRU-initiated positioning (e.g., WTRU-based MO-LR), the WTRU may receive at least a part of the configuration associated with training for supporting ML/AI for positioning in a broadcast transmission. The WTRU may receive additional configuration information (e.g., new training data/model parameters) by sending one or more on-demand request indications to the network when triggered by conditions related to learning performance, for example. This example may be applicable for supporting ML/AI methods for positioning when the WTRU operates in power saving modes (e.g., RRC Idle/Inactive).

In another example, a WTRU may initiate a training procedure after detecting that it is in proximity of a physical object the position of which is known (“reference station”). The WTRU may detect proximity to a reference station by at least one of receiving a signal (such as from Bluetooth, WiFi or RFID), by proximity sensor, or by camera using a code reader or other visual information. The WTRU may also obtain additional information from the reference station, such as a station identifier or the position of the station. In such a scenario, the training input may comprise PRS measurements and signals received from the reference station, if any. The expected output may comprise the position of the reference station and the actual output may comprise the estimated position of the reference station. The WTRU may determine at least one of the positions of the reference station, the PRS configuration, and training configuration using at least one of the following solutions:
Receiving a message from the reference station;
Looking it up from the reference station identifier using a pre-configured mapping. The WTRU may have obtained such pre-configured mapping from previous signaling.
Including a reference station identifier in a first message and receiving the information from a second message, where the first and second messages may be part of the training procedure. For example, the first message may be the WTRU's request for training. The WTRU may also include an indication of a maximum distance from the reference station in the first message.

The WTRU may detect that it is no longer in proximity of a reference station. In such case, the WTRU may indicate this information to the network, possibly by initiating a new training procedure.

In network-initiated positioning (e.g., MT-LR), the request for WTRU location information may originate from an application function and be sent to the network (e.g., RAN or LMF) or WTRU.

The following procedures, related to capability transfer, assistance information transfer, and learning status/measurement reporting (for either WTRU-based training or WTRU-assisted training), are similar to those of WTRU-initiated positioning.

The WTRU may receive the training data/model directly from an application. In this case, the LMF or RAN may not be aware of the status of the training. To ensure that the RAN/LMF can assist the WTRU with the training (e.g., assure that the predicted positioning information at the WTRU conforms with what the RAN/LMF expects), the WTRU may request and/or receive configurations or measurements and reports to the RAN/LMF. For example, the WTRU may include a flag in the request or report indicating that the training is initiated by the application. Indication that the training is initiated by the application may be implicit. For example, the WTRU may send a request for training data with a (pre)configured duration without exchanging capability information with the LMF or RAN. In such a case, the LMF or RAN may be notified that the external application triggered training.

Using the online training, the machine learning model at the WTRU can be trained faster, improving the resource usage efficiency.

### Configuration of Multiple Positioning Methods From the LMF and Reconfiguration of PRS

The WTRU may receive an indication from the network (e.g., LMF or gNB) to report inference data to the network at a specified periodicity. When the WTRU receives such an indication from the network, the WTRU may also receive an indication about positioning methods to use (e.g., DL-TDOA, DL-AoD). For example, the WTRU may use DL-TDOA and DL-AoD and report an inference value obtained from the machine learning model for each positioning technique. The WTRU may receive PRS configurations specific to each positioning method. For example, the WTRU may receive from the LMF boresight angles of PRS transmission for each TRP for DL-AoD positioning methods. The WTRU may receive information about a reference station (e.g., TRP ID) with which TDOA or RSTD is computed.

### Reconfiguration of PRS Parameters

If different positioning methods (e.g., timing-based and/or angle-based positioning methods) are configured for the WTRU, after the WTRU reports inference data to the network, the WTRU may expect PRS reconfiguration if one of the inference values is larger than a (pre) configured threshold. For example, the weights (i.e., inference values) for DL-AoD and DL-TDOA may be 0.8 and 0.2, respectively. If the (pre)configured threshold is 0.7, after reporting inference to the network, the WTRU may receive PRS with reconfigured parameters for DL-AoD (e.g., increased number of symbols, more frequent periodicity). For the positioning method with higher inference, the WTRU may expect optimized PRS configuration from the network.

### Automatic Reconfiguration

The WTRU may receive at least two PRS parameter sets from the network. A parameter set may include PRS parameters such as periodicity or number of symbols, as previously mentioned. The first PRS parameter set may be a default parameter set which is configured to the WTRU initially. The second parameter set may be the set used for reconfiguration. After the WTRU determines that the inference value is above the (pre)configured threshold and reports that inference value to the network, the WTRU may determine that the network will change the PRS parameters to the second set. Thus, the WTRU may prepare to receive PRS with the second set of PRS parameters.

If the WTRU receives PRS associated with the second set of parameters and if the inference value associated with that PRS falls below the (pre)configured threshold, the WTRU may determine, after reporting inference values to the network, that the network should switch the PRS parameters back to the default set of parameters.

The WTRU may receive multiple thresholds from the network. In this example, let us assume that the WTRU uses one positioning method for training the machine learning model. In this case, the WTRU may receive multiple sets of PRS parameters and associations of threshold ranges to those sets of PRS parameters. Let us also assume that the first set of PRS parameters is the default/initial set of PRS parameters. For example, the WTRU may receive thresholds 0.7 and 0.9 and three sets of PRS parameters, namely the first, second and third set of PRS parameters. If the inference value is above 0.7 but below 0.9 for the initial set of PRS parameters, the WTRU may determine, after reporting the inference values to the network, that the network will switch to the second set of PRS parameters. If the inference value for the initial set of PRS parameters is above 0.9, the WTRU may determine, after reporting the inference values to the network, the network will switch to the third set of PRS parameters. If the inference value for the initial set of PRS falls below 0.7, the WTRU may determine, after reporting the inference values to the network, that the network will keep the first set of PRS parameters, which is the default PRS parameter.

### Switching Training Data During Training

In a static environment, during online training, parameters of the machine learning model may not change dynamically, causing long latency in training. In such a scenario, the network (e.g., LMF or gNB) may change training data during PRS transmission to accelerate training of the machine learning model.

### Automatic Training Data Switching

The WTRU may receive conditions under which the network may or will initiate changes in PRS parameters and indication from the network that changes in PRS transmission will occur. Herein, “changes in PRS parameters” may include a preconfigured sequence of TRP patterns, muting patterns, or PRS parameters patterns that the network uses to transmit PRS to accelerate training of the machine learning model, for example. The WTRU may determine that the network may initiate changes in PRS transmission parameters if at least one of the following conditions is satisfied:
Standard deviation/variance/range of the values of parameters (e.g., weights) in the machine learning model is below or equal to a preconfigured threshold for a preconfigured duration
Standard deviation/variance/range of the estimated position returned by the machine learning model is below or equal to a preconfigured threshold for a preconfigured duration
Standard deviation/variance/range of the inference value returned by the machine learning model is below or equal to a preconfigured threshold for a preconfigured duration
Standard deviation/variance/range of the error metric returned by the machine learning model is below or equal to a preconfigured threshold for a preconfigured duration
The error metric returned by the machine learning model is above or equal to a preconfigured threshold for a preconfigured duration

The network may initiate changes in PRS transmission using at least one of the following methods:
The WTRU may receive a switch pattern for switching among TRPs from which PRS are transmitted. For example, the WTRU may be configured to receive PRS from 9 TRPs, with TRP ID TRP_0 through TRP_8. The WTRU may receive a pattern of TRPs from which the WTRU is to receives PRS. If the WTRU requires reception of PRS from 3 TRPS to obtain a position estimate or to generate a measurement report, an example of a switch pattern may be {TRP_0, TRP_1, TRP_2}, {TRP_3, TRP_4, TRP_5}, {TRP_6, TRP_7, TRP_8}. For each element (group of three TRPs) in the switch pattern, the WTRU may receive a duration (e.g., slots, frames, time) during which PRS is to be received from the indicated TRPs. For example, the WTRU may first receive PRS from {TRP_0, TRP_1, TRP_2} for 10 ms. For the next 10 ms, the WTRU is to receive PRS from {TRP_3, TRP_4, TRP_5}. Subsequently, the WTRU is to receive PRS from {TRP_6, TRP_7, TRP_8} for 10 ms. Then, the pattern may repeat.
The WTRU may receive muting patterns for each TRP. Once the network initiates change(s) in PRS transmission, the WTRU may determine that the network applies a preconfigured muting pattern to each TRP. The muting pattern for each TRP may change periodically. The WTRU may receive configurations for muting patterns for each TRP, periodicity of the changes in the muting pattern, and a sequence of changes in the muting pattern for each TRP.
The WTRU may receive a pattern of boresight directions (AoD from the gNB) for PRS transmission for each TRP. The WTRU may receive PRS from preconfigured directions following the preconfigured pattern. Such changes in transmission direction may be beneficial when there is a blockage between the WTRU and the network. For each angle of PRS transmission, the WTRU may receive a duration in terms of slots, frames, or time.

For the above method, the WTRU may receive PRS parameters such as number of symbols, periodicity of PRS transmission, repetition factor, and/or comb value from the network.

### Changes in PRS Transmission are Initiated by the WTRU

In another method, the WTRU may initiate changes in PRS via on-demand request. If at least one of the aforementioned conditions is satisfied, the WTRU may send an on-demand request to the network to initiate changes in PRS. The WTRU may include type of changes (e.g., aforementioned TRP changes or muting pattern changes, PRS transmission angle).

### Turning Off the PRS Changes

The WTRU may determine to terminate PRS changes based on at least one of the following conditions:
Standard deviation/variance/range of the values of parameters (e.g., weights) in the machine learning model is above a preconfigured threshold for a preconfigured duration
Standard deviation/variance/range of the estimated position returned by the machine learning model is below or above a preconfigured threshold for a preconfigured duration
Standard deviation/variance/range of the inference value returned by the machine learning model is above a preconfigured threshold for a preconfigured duration
Standard deviation/variance/range of an error metric returned by the machine learning model is above a preconfigured threshold for a preconfigured duration
The error metric returned by the machine learning model is below a preconfigured threshold for a preconfigured duration

The WTRU may determine that, after changes in PRS transmission is terminated, the PRS configuration used prior to PRS change is used by the network. Alternatively, the WTRU may determine that the default PRS transmission is configured by the network (if a default PRS configuration exists).

### Reference Point Determination

In one method, the WTRU may receive the default source for the reference point (e.g., GNSS) from the network (e.g., LMF or gNB) to train the machine learning model. During training, the WTRU may determine to switch to different reference points based on the reliability/quality of the reference point (e.g., RSRP of GNSS signal, RSRP of Wi-Fi signals, sensor-based positioning). The WTRU may receive candidates for the reference point from the network with a priority order (e.g., highest priority given to GNSS, the second highest priority is sensor-based positioning). If the quality of the default reference point (or the reference point with the highest priority) is below the preconfigured threshold, the WTRU may determine to use the reference point with the second highest priority. If the WTRU is configured with two candidates for the reference point and the quality of the reference point with the second highest priority is below the preconfigured threshold, the WTRU may determine to send a request to the network to terminate training or switch to default positioning (e.g., positioning method such as DL-TDOA without using the machine learning model) since the WTRU does not have any reference points it can use for training the machine learning model.

In another example, if the WTRU is configured with only one reference point and the quality of the reference point is below the preconfigured threshold (e.g., RSRP of GNSS is below the preconfigured threshold), the WTRU may determine to send a request to the network to terminate training or switch to the default positioning method (e.g., positioning method such as such as DL-TDOA without using the machine learning model) since the WTRU does not have any reference points it can use for training the machine learning model.

In another example, if the WTRU is configured with more than one reference point and the quality of none of the reference points is above the preconfigured threshold, the WTRU may determine to send a request to the network to terminate training. If the WTRU is configured with one reference point and the quality of the reference point is below the preconfigured threshold, the WTRU may determine to switch to the default positioning method (e.g., positioning method such as DL-TDOA without using the machine learning model).

When the WTRU determines to switch to the default positioning method, the WTRU may determine to send a request to the network to configure the default PRS configurations for the positioning method.

The WTRU may send the first position estimate made by using the default/initial reference point with the machine learning model. The WTRU may report confidence values related to the position estimate such as standard deviation, variance, inference values, or range. Based on the location estimate, inference values, and/or confidence values, the WTRU may receive the second reference point which the WTRU may use to derive the second position estimate.

### Discovery of the Reference Point by Sidelink

The WTRU may receive an indication from the network (e.g., LMF or gNB) to search for a reference point nearby. In this case, the WTRU may not receive a list of reference points (e.g., GNSS, Wi-Fi) from the network. The WTRU may discover the reference point by sidelink.

The WTRU may determine to obtain the location of the reference point when at least one of the following conditions is satisfied:
The reference point is within a preconfigured distance from the WTRU″
RSRP of reference signals or signals transmitted from the reference point is above a preconfigured threshold

Subsequently, the WTRU obtains the location of the reference point by sidelink and obtains the WTRU's location using relative positioning using the location of the reference point. The WTRU may use the obtained location of itself as the reference point during training. If the WTRU cannot find the reference point within the preconfigured distance, the WTRU may send a request to the network for a list of reference points with the aforementioned priority indication for each reference point.

### WTRU Behavior During Training as the Reference Point

In another method, the WTRU may receive its own position from the network, indicating that the WTRU serves as the reference point. If the WTRU serves as the reference point, the WTRU may not receive candidates for reference points. In addition, the WTRU may receive multiple sets of PRS configurations from the network so that the WTRU can determine which set(s) accelerate training for the machine learning model. If the WTRU receives an indication from the network to train the machine learning model and the WTRU serves as the reference point, the WTRU may determine to send the network recommended set of training parameters after the training is complete. Examples of recommended sets of training parameters may include at least one of the following:
A subset of TRPs from which PRS is transmitted
Periodicity (or periodicities) of PRS
Number(s) of PRS symbols
Repetition factor(s)
Comb value(s)
Number of PRS resource(s) in a PRS resource set
Subset of PRS resource(s) in a PRS resource set

### 5.2.2 Training Procedure: Training During Initial Access

### Using SSB, During 2/4 Step RACH, Training Status can be Reported by the WTRU

### Positioning Training Signals Configuration

In some solutions, a WTRU may be configured to initiate training procedure for positioning during initial access. A WTRU may be configured using broadcasted system information to determine the set of reference signals (called in this section Positioning Training Signals) that can be used by the WTRU for training procedure for positioning. Positioning training signals may include PRS, CSI-RS (Channel State Information Reference Signal), TRS (Total Radiated State), PTRS (Phase Tracking Reference Signal), DMRS (Demodulation Reference Signal), or other reference signals specifically designed for training a machine learning model at the WTRU. For example, an existing System Information Block (SIB) or new SIB can be used to indicate the configuration of the reference signals to be used during training procedure. Alternatively, the configuration of the positioning training signals can be fixed in the specification and the configuration may depend on some broadcasted signals such as Synchronization Signal Blocks (SSBs). For example, the Positioning Training Signals may be having the same SSB periodicity and/or a preconfigured offset relative to the position of the SSBs. The configuration of positioning training signals may include one or more of the following:
Periodicity of the Positioning Training Signals
Offset of the Positioning Training Signals
Bitmap indicating the occurrence of the Positioning Training Signals within the period of the transmission
Sequence. For example, a sequence-based signal can be used during the training procedure. The length of the sequence as well as the type of the sequence (e.g., pseudo-random sequence) can be part of the configuration
Transmission power of the Positioning Training Signals. The transmission power may be used during the training procedure to estimate the path loss. In one example, the transmission power can differ from one cell to another and the WTRU receives the configuration using broadcasted system information. In another example, the transmission power can be the same across different cells and fixed in the specification.

In some solutions, a WTRU may be configured to use the SSB of one or multiple cells as training signals (including PBCH (Physical Broadcast Channel)/DMRS of PBCH, Primary Synchronization Signal (PSS) and Secondary Synchronization Signal (SSS). For example, a WTRU may be configured to use the SSBs of only the cell that the WTRU is trying to access. In another example, a WTRU may be configured to use both the SSB of the cell that the WTRU is trying to access and other SSBs belonging to other cells. A WTRU may be configured with the cell IDs of the other cells that can be used for training using SIB messages. Based on the configuration, the WTRU may search for the SSBs transmitted from other cells such as neighboring cells and use them and their contents for training if they are discovered. Alternatively, the WTRU may receive the configuration of the SSBs of the other cell(s) directly from the cell that the WTRU is trying to access. A WTRU may be configured to use SSBs of other cell(s) in a different way than the SSBs of the cell that the WTRU is trying to access. For example, a WTRU may use SSBs of other cells with different coefficients than SSBs of the cell when determining the estimation function of the position during the training procedure.

In some embodiments, a WTRU may be configured to use a combination of SSBs and the configured positioning training signal during the training process. In one example, a WTRU may be configured to use the Positioning Training Signals and SSBs with different “variable importance” during the training process. A variable importance is an indicator of how important a parameter/variable is to make a prediction/estimation of the position/location. For example, the Positioning Training Signals may be configured with higher “variable importance” than SSBs, which would mean that the WTRU relies more on Positioning Training Signals than SSBs for positioning. The variable importance coefficients can be configured using SIBs or alternatively fixed in the specification.

### WTRU to Transmit Training Reports

A WTRU may be configured to transmit the training reports during the random-access procedure. In one embodiment, a WTRU may be configured to transmit the training report using pre-amble signal of msg 1/msgA. For example, a WTRU may be configured with a mapping between the training statuses and/or measurement results and a set of Physical Random Access Channel (PRACH) pre-ambles. A WTRU then selects the PRACH preamble from the set corresponding to its training status/measurement results. The mapping between training statuses and/or measurement results may be fixed in the specification or alternatively broadcasted using system information. In another embodiment, a WTRU may be configured to transmit the training report using data message of msgA/msg3. For example, a WTRU may report the training status using a new (Medium Access Control (MAC) Control Element (CE) within the msgA/msg3.

The training status may include the difference between the estimated position and the position obtained from the GNSS module.

### WTRU to Receive Training Reconfiguration

A WTRU may receive training reconfiguration after sending the training report. The WTRU may receive the reconfiguration in msg2/msg4 or msgB. The training reconfiguration may include one or more of the following:
Reconfiguration of Positioning Training Signals (including the periodicity, offset, bitmap, sequence and transmit power)
Indication to stop/start using SSBs in the training procedure (including enabling/disabling a set of SSB of other cells)
Reconfiguration of the “variable importance” corresponding to Positioning Training Signals and/or SSBs
Reconfiguration of how the WTRU can transmit the training reports. For example, a WTRU may receive a PUCCH configuration on which the WTRU will periodically report the training report.

### 5.2.3 Training Procedure: Geographically Dependent Training

### Mode of Positioning Operations With/Without AI/ML Functionalities

Hereafter, AI/ML functionality may be referred to as a function, scheme, training data/model which may be used to determine a positioning information.

In a solution, one or more of modes of operations for positioning may be used. One or more of the following may apply:
A mode of operation for positioning may be determined or used based on at least one of the following:
   In an example, a first mode of operation may use single stage positioning, which may estimate positioning without AI/ML functionality; and a second mode of operation may use two-stage positioning, which may first estimate positioning without AI/ML functionality as a first stage and then update the estimated positioning information with AI/ML functionality in a second stage; wherein, the configurations, parameters, model, and/or training information for the AI/ML functionality may be determined based on the estimated positioning information from the first stage
   In another example, a first mode of operation may use one or more positioning schemes without any AI/ML functionality to estimate positioning information; and a second mode of operation may use one or more positioning schemes with one or more AI/ML functionalities
A mode of operation may be determined based on at least one of the following:
   the accuracy of a positioning scheme. For example, if the positioning accuracy of a first mode of operation is lower than a threshold, a WTRU may switch to a second mode of operation. Otherwise, the WTRU may stay with the active mode of operation
   the availability of a signal or a channel. For example, a first mode of operation may be used for positioning if a first type of signal (e.g., GNSS) is available. Otherwise, a second mode of operation may be used for positioning
   the quality of a signal of a channel. For example, a first mode of operation may be used for positioning if a signal quality of a signal (e.g., PRS) is higher than a threshold; otherwise, a second mode of operation may be used for positioning

### Two-Stage AI/ML Based Positioning

In a solution, a WTRU may determine, receive, or be configured with AI/ML related parameters and/or configurations based on first stage positioning information, wherein the first stage positioning may be positioning information (e.g., either WTRU-based or WTRU-assisted positioning) that may be estimated without AI/ML functionality. Then, the WTRU may adjust/update the positioning information acquired from the first stage by using AI/ML based positioning information. One or more of following may apply:
A WTRU may receive one or more sets of parameters and/or configurations for AI/ML functionalities and each set of parameters and/or configurations for AI/ML functionalities may be associated with geographical location information for a WTRU. For example, one or more zones may be defined or configured, and each zone may be associated with a non-overlapped geographical region; each set of parameters and/or configurations for AI/ML functionalities may be associated with a zone (e.g., zone identity)
   The zone may be determined based on the positioning information of the first stage
   The positioning information may be updated with the positioning information estimated from the AI/ML based positioning scheme, which may be based on the set of parameters and configurations for the AI/ML functionalities determined based on the zone identity determined from the first stage

### Training Method/Parameter Adaptation

For a positioning scheme with AI/ML functionalities, the training method/parameters may be adapted based on the WTRU's geographical information (or location information). One or more of the following may apply:
For training, one or more method/parameters may be used. For example, a first training method may be based on a first type of information (e.g., positioning information from GNSS); a second training method may be based on a second type of information (e.g., positioning information without GNSS)
A WTRU may determine which training method to use based on at least one of the following:
   Availability of a signal (e.g., GNSS, Wi-Fi, etc.)
      A priority of signals may be predefined. Based on the priority of signals, the training method may be determined. For example, if GNSS and Wi-Fi are available for training, the training method with GNSS may be used or determined
   Quality of a signal (e.g., RSRP of GNSS signal, RSRP of PRS, presence of LoS)
   Accuracy of the positioning information

### 5.2.4 Association Between WTRU Capabilities and Training Data/Training Procedure

### WTRU-Capability for AI Based Positioning

### Training Data Size Depending on WTRU Capability

In one solution, the WTRU may receive training data and/or pre-trained model parameters whose attributes (e.g., training data size, training duration, weights) may be dependent on the WTRU's capability for supporting ML/AI methods for positioning. The WTRU may send the capability information, associated with supporting ML/AI, to the network in the following scenarios:
During positioning session/service establishment, when triggered by MO-LR/MT-LR request
Upon receiving a capability transfer request from the RAN or Core Network (CN) function (e.g., LMF via LPP signaling), where the request may include capability for supporting ML/AI for positioning
When triggered by other dynamic factors (e.g., change in WTRU environment, change in neural network model or machine learning model computation load, expiry of timer)

### Descriptions of WTRU Capability

The capability information sent by the WTRU, which may be semi-static or dynamic, may comprise one or more of the following:
Number and types of positioning methods/configuration, including RAT-Dependent methods (e.g., DL-PRS based, UL-SRSp based) and RAT-Independent methods (e.g. GNSS, WiFi, sensor based optical/inertial tracking), supported by the WTRU
Number of positioning methods/configurations that may be supported concurrently
Types of RS supported for positioning (for measurements and/or transmission)
Number of time/frequency resources, resource sets, and/or beams that may be monitored for positioning
Dynamic information on the WTRU's environment and/or WTRU trajectory (e.g., detectable cell IDs, indoor/outdoor, expected mobility pattern)
Capability for supporting different sensors (e.g., camera, accelerometer, gyroscope) and fusing sensor data for positioning
Capability for supporting ML/AI methods and associated parameters for positioning including
   Type of training and/or learning mechanisms supported (e.g., online/offline training)
   Hyperparameters related to topology and size of one or more neural network or machine learning architectures that are supported: maximum number of hidden layers, maximum number of neurons in each layer, connectivity/capacity of neurons, activation functions, initial weights, neural network model or machine learning model implementation parameters (e.g., GPU/CUDA attributes)
   Parameters related to training algorithms that are supported: type of loss function, number of epochs/iterations per time duration, learning rates, dimensions of training data, sizes of mini batches
   Dynamic ML/AI attributes: Computation load available at neural network or machine learning model (for example, represented as number of operations per second), available number of layer/neurons-per layer (for example, represented as the amount of memory available), priority assigned to neural network or machine learning model for positioning
   Training history: Training data applied in the past (IDs), learned algorithm parameters (e.g., weights from previous training phases)
Capability for supporting federated learning for positioning, where the training/learning may be distributed between WTRU and network for WTRU-based and/or WTRU-assisted positioning. An example of federated learning could be a procedure in which the network and the WTRU share the same machine learning model and the WTRUs and the network may periodically share or transfer the parameters in the machine learning model with or to other WTRUs and network so that training can be accelerated.

### Content the WTRU may Receive After Transmitting WTRU Capability

Upon sending the capability information, the WTRU may receive the associated ML/AI configuration for positioning. Such configuration may comprise one or more of the following attributes: training data set, pre-trained model parameters, resource configuration for training and configuration for sending training status report (e.g., learning performance thresholds, periodicity). The attributes associated with ML/AI configuration may be received by the WTRU, either directly or indirectly, from one or more of the following: RAN, CN function (e.g., LMF), application function (e.g., LCS client, 3rd party external function).

### Mapping Between WTRU Capability and Received Training Data

In an example, the different capability information may be associated with different training data sets, comprising one or more data elements, and the corresponding identifiers/IDs. The WTRU may use a (pre)configured mapping between different capability information and the ML/AI configuration (e.g., IDs associated with training data set) when sending the capability information. The WTRU may subsequently receive configuration information, semi-statically or dynamically, based on the indicated capability, as an example. For instance, a WTRU indicating that it has the capability to support a neural network model or machine learning model with certain architecture/topology and/or computation load of the neural network or machine learning model may receive a configuration comprising training data set and/or model parameters that may be specific to the supported neural network or machine learning model. The training data received by the WTRU may be customized (e.g., with appropriate dimensions and/regularization) based on the indicated capability for handling the data set during training, for instance. In another example, the WTRU may receive training data and/or configuration which may be agnostic to the neural network model or machine learning model and/or ML/AI algorithm supported by the WTRU when indicating capability to support ML/AI without/with the information on neural network in the capability information.

### How Frequently the WTRU may Receive the Training Data

The WTRU may receive the ML/AI associated configuration for positioning (e.g., training data/model parameters) in assistance information, possibly in one or more of the following assistance data delivery modes:
Aperiodic: For example, the configuration comprising the initial training data set/model parameters may be received by the WTRU upon sending capability information
Periodic: For example, the WTRU may receive training data/model parameters periodically in one or more batches, of the same or different sizes, based on the learning rate, transmission of dynamic capability information, and/or transmission of training status report
Semi-persistent: For example, the WTRU may receive training data/model parameters periodically in one or more batches over a certain duration during that the WTRU may operate in a training phase

### How the WTRU may Receive Training Data

Upon triggering by the positioning service request and/or sending the capability information, the WTRU may receive the ML/AI associated configuration for positioning (e.g., assistance information containing training data/model parameters) in one or more of the following:
Broadcast/Multicast signaling
   For example, the WTRU may receive at least part of the ML/AI configuration in broadcast signaling (e.g., SIBs), which may be common to multiple WTRUs who have similar capability and/or are triggered to be trained with a common training data set. The configuration and/or training data received in broadcast signaling may be intended to achieve uniformity in training amongst a group of one or more WTRUs, for example. In this case, a group of WTRUs may be configured with a set of security keys for decoding the configuration and/or training data received in broadcast/multicast signaling.
   In an embodiment, the WTRU may receive indication of an association between a multicast group and a characteristic of training data set. The WTRU may be configured to join the multicast group to receive the training data based on various preconfigured triggers, e.g., based on need for positioning or accuracy thereof, status of training, etc.
   In a solution, the training data sets may be grouped into different system information blocks. The WTRU may receive indication of availability of different SI blocks and at least one characteristic of a training data set. The WTRU may be configured to determine if one or more training data sets are required. Possibly based on various preconfigured triggers, for example, based on need for positioning or accuracy thereof, status of training, etc. The WTRU may check if the relevant training data is broadcasted. Otherwise, the WTRU may be configured to trigger an on-demand system information acquisition procedure to acquire the SI associated with the relevant training data set.
Dedicated signaling
   For example, the WTRU may receive in dedicated RRC and/or NAS signaling (e.g., LPP) the ML/AI configuration (e.g., training data), which may be specific to the WTRU's semi-static and/or dynamic capability.
On-demand signaling
   For example, the WTRU may send an on-demand request for at least part of an ML/AI configuration (e.g., additional training data set) based on the progress and/or performance of learning. In this case, the WTRU may send the on-demand request upon receiving an indication and/or part of the ML/AI configuration in broadcast/dedicated signaling.
   For example, the on-demand request associated with ML/AI training may include densities of RS needed for training, information on set of TRPs/gNBs, configuration to allow a combination of different positioning methods, additional downloadable model parameters, etc.
   In an example, the WTRU may send an on-demand request for additional training data when the achieved learning performance/convergence improves progressively (e.g., when the error, difference, or loss metric between predicted and reference positioning information drops below a threshold). In another example, the WTRU may send an on-demand request for different training data set when the WTRU is unable to converge (e.g., low/no improvement in positioning accuracy) within a configured learning duration with the existing training data set.
   The on-demand request, possibly containing the IDs associated with the ML/AI configuration/training data, may be sent in higher layer signaling (e.g., RRC, NAS) or lower layer signaling (e.g., MAC CE, UCI), for example.

### 5.2.5 Training Behaviour in Changing Environment, Triggers to Train or Send On-Demand Request for Additional Data

### WTRU Triggers Request for Training Data

In one embodiment, the WTRU may trigger on-demand requests for training data. Specifically, the WTRU may request one or any combination of the following:
More training data
Reconfiguration of training data
A different set of training data
Stop training procedure

The WTRU may be (pre-)configured with a set of request indices, wherein each index may be associated with one or more of the training data requests. The WTRU may request the desired training data by indicating the index of the (pre-)configured request. For example, the WTRU may be (pre-)configured with two training data request indices. The first index may be associated with the on-demand dynamic DL-PRS, and the second index may be associated with the on-demand periodic DL-PRS. The WTRU may then indicate the (pre-)configured index in the request for training data.

### WTRU Requests More Training Data

The WTRU may request more training data. In one approach, the WTRU may request additional DL-PRS and associated assistant data from the network. The WTRU may use a WTRU-based DL-based positioning method to derive its position. In another approach, the WTRU may request additional DL-PRS and UL-PRS and associated reporting from the network. The WTRU may use WTRU DL&UL-based methods to derive its position. The WTRU may request either additional dynamic, semi-persistent, and/or periodic DL-PRS and/or UL-PRS to feed its training model.

### WTRU Requests Reconfiguration of Training Data

The WTRU may request one configuration and/or a reconfiguration of the training data. The configuration of the training data may include one or any combination of the following:
PRS resources. The PRS (DL-PRS and/or UL-PRS) resource may include one or any combination of the following:
   The bandwidth for each PRS transmission
   The number of repetitions
   Sequence ID
   Cyclic shift
   Muting pattern
   Time/frequency offset
   Comb value
   The type of PRS and periodicity (for periodic PRS).
      Dynamic PRS
      Semi-persistent PRS
      Periodic PRS.
The number of TRPs. For example, one configuration of a training data configuration may include 3 TRPs regardless of the TRP ID and another training data configuration may include 6 TRPs regardless of TRP IDs.
The set of TRP IDs for each configuration
The transmission power of each TRP
The associated assistant information

The WTRU may be (pre-)configured with a set of training data (re) configurations. The WTRU may then request its desired (re-)configuration in the request message.

### WTRU Requests a Different Set of Training Data

The WTRU may request a different set of training data. Specifically, the WTRU may be (pre-)configured with multiple positioning methods. Each positioning method may be associated with one set of training data. The WTRU may then request which positioning method may be used for the training procedure. For example, the WTRU may be (pre-)configured with two positioning methods, e.g., one angle-based method and one timing-based method. The WTRU may then request one of the two sets to train the model based on its selected positioning method.

In one method, if the WTRU is configured to use more than one positioning method to train the machine learning model, as shown in FIG. 3 for example, the WTRU may request the LMF for reconfiguration of PRS parameters based on inference data returned by the machine learning model.

For example, if the highest inference value among inference values returned by the machine learning mode, where each interference value corresponds to each positioning method, is above the preconfigured threshold, the WTRU may request reconfiguration of PRS parameters associated with the positioning method which has the highest inference value among the positioning methods.

Alternatively, if the lowest inference value is below the preconfigured threshold, the WTRU may request reconfiguration of PRS parameters associated with the positioning method corresponding to the lowest inference value among the positioning methods. The WTRU may send the request for PRS reconfiguration for the positioning method with the lowest inference value to increase the inference value. The intention here is to fix the PRS parameters for the worst-performer so that training can be accelerated/positioning accuracy can be improved. In other embodiments, the same might be done for all positioning methods that fall below some threshold, but that may require more signaling and data exchange to improve all the poor performers than is warranted.

If none of the inference values associated with positioning methods satisfy any conditions (i.e., the lowest inference value is not below the preconfigured threshold and the highest inference value is not above the preconfigured threshold), the WTRU may not make a request to the LMF for reconfiguration of PRS parameters. Rather, the WTRU may complete the training simply by sending to the LMF an indication that training completion criteria is satisfied (e.g., training duration has expired).

The WTRU may receive one or more sets of PRS parameters from the LMF corresponding to each positioning method the WTRU may use to train the machine learning model. The WTRU may request the LMF for a new configuration of PRS parameters using the index associated with the set of PRS parameters. The WTRU may determine which PRS parameter set to request based on the inference value threshold(s) configured by the network (e.g., gNB or LMF) and inference values returned by the machine learning model.

In an example, the WTRU is configured with a threshold, Th1 for the inference value, and wherein the WTRU is configured to use positioning method A to train the machine learning model. In addition, the WTRU is configured with two sets of PRS parameters for the positioning method. Let us name the two sets of PRS parameters for positioning method A as PRS set A1 and PRS set A2. Different sets of PRS parameters may correspond to different numbers of time/frequency resources used for PRS. In the above example, PRS set A2 may contain a PRS configuration with more symbols and/or bandwidth than PRS set A1. Let us also assume that the initial/default set of PRS parameters is PRS set A1. After training the machine learning model with the initial set of PRS parameters, i.e., PRS set A1, let us assume for sake of example that the PRS set A1 yields an inference value obtained from the machine learning model that is greater than Th1. In such case, the WTRU may send a request to the network to configure PRS set A2. If PRS set A2 yields an inference value that is less than Th1, the WTRU may not send a request to the LMF for reconfiguration of PRS parameters.

The WTRU may send one or more inference values along with the request for PRS reconfiguration to the network.

Once the requested PRS parameters are acknowledged by the network (e.g., LMF or gNB), the WTRU may use the configured PRS parameters for a preconfigured duration of time. Alternatively the WTRU may start a timer and continue to use the reconfigured PRS parameters until the timer expires. Once the preconfigured duration ends, the WTRU may determine to use the initial/default PRS configuration for training.

### WTRU Triggers Request for Training Data Based on a (Pre-)Configured Triggering Condition

The WTRU may trigger the on-demand request for training data based on one or any combination of the following conditions:
The WTRU detects a change in input data. The change in the input data may be one or any combination of the following:
   Changes in current RSRP for PRS received compared to the last RSRP measurement being greater/or smaller than a threshold.
   The observed number of paths in the channel being greater/smaller than a threshold.
      For example, the WTRU may determine that one TRP does not have Line of Sight (LoS) due to the number of paths being greater than a threshold. The WTRU may request a different configuration of training data to a different set of TRPs to eliminate the Non-Line of Sight (NLoS) TRP.
   The received PRS time becomes greater/smaller than a threshold.
      For example, the WTRU may request to change the configuration of training data to reduce the number of TRPs since the received PRS time may not satisfy the latency requirement of the positioning service.
   RSRP becomes greater/lower than a (pre-)configured threshold.
      For example, in order to increase the accuracy of the training result, the WTRU may request to increase periodicity in PRS transmission when the RSRP corresponding to the PRS become smaller than a threshold
   Change in WTRU speed becomes greater/smaller than a threshold.
      For example, the WTRU may request on-demand DL-PRS if the WTRU speed becomes greater than a threshold. This approach may be motivated to increase the accuracy of the training method due to a high-speed WTRU.
The WTRU detects a change in the output of the training model.
   The weight comparing the accuracy/efficiency of two or more positioning methods becomes greater/smaller than a threshold.
      For example, the WTRU may request a different set of training data to switch the positioning methods based on the weight output.
   The loss function becomes greater/smaller than a threshold.
      For example, the WTRU may request to stop training if the change in the loss function is negligible (smaller than a threshold) for a (pre-)configured step. The trigger may indicate that the WTRU already finish the training procedure.
   The change in the loss function after a (pre-)configured training step become greater/smaller than a threshold.

### Different Trigger Conditions for Different Type of Request(s)

The WTRU may change the content of the on-demand request based on the condition related to the training status. An example of the request may be the following.
If the error metric returned by the machine learning model is above a first preconfigured threshold, the WTRU may send a request to the network to switch to offline training and request training data
If the error metric returned by the machine learning model is above a second preconfigured threshold that is lower than the first preconfigured threshold, but below the first preconfigured threshold, the WTRU may send a request to the network to increase frequency of transmission of PRS from TRPs
If the error metric returned by the machine learning model is above a third preconfigured threshold that is lower than the second preconfigured threshold, but below the second preconfigured threshold, the WTRU may send a request to the network to increase the number of TRPs from which the WTRU receives PRS.

The metric and associated thresholds in the above method is not limited to the error metric. For example, the metric can be inference values returned by the machine learning model, standard deviation or variance or range of the positioning estimate returned by the machine learning model.

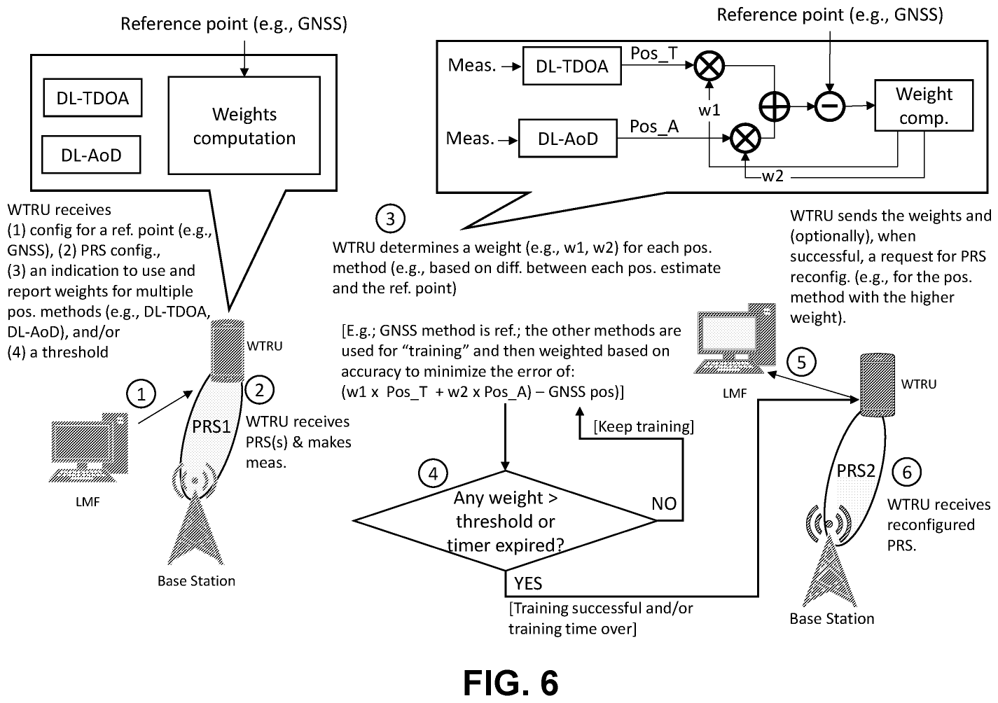

FIG. 6 illustrates an example of a training-based positioning scheme for wireless communications. Referring to FIG. 6, a WTRU is configured to receive a positioning reference signal (PRS) configuration, an indication to use (and report weights for) a plurality of positioning methods, configuration for a reference point, and/or a threshold. The WTRU may be configured to receive and measure one or more PRSs based on the PRS configuration, and determine respective positioning estimates for the reference point and each of the plurality of positioning methods. The WTRU may be configured to determine a weight for each of the plurality of positioning methods (e.g., based on 1) the respective positioning estimate for each of the plurality of positioning methods and 2) the positioning estimate for the reference point), and the sum of the determined weights is 1. On condition that at least one determined weight is greater than the threshold (or a time period (for training) has ended/expired), the WTRU may send the weights. In some cases, when at least one determined weight is greater than (or equal to) the threshold, the WTRU may send a request to reconfigure the PRS for the positioning method with the highest weight. In an example, the WTRU may further receive a PRS reconfiguration, and measure one or more PRSs based on the PRS reconfiguration.

In one embodiment, the WTRU may determine weights for multiple positioning methods and request PRS reconfiguration (e.g., based on the determined weights). For example, the WTRU may receive an indication to use multiple positioning methods and determine weights for the positioning methods based on positioning estimates (for the positioning methods and for a reference point (e.g., GNSS)). If at least one weight is greater than a threshold (training successful) or a timer expires (training ends), the WTRU reports the weights. Optionally, when successful, the WTRU requests PRS reconfiguration (e.g., for the positioning method having a higher weight).

### Distribution of Correction Information by the Network

Source of correction information. A WTRU may receive correction information from the network (e.g., LMF, gNB) related to measurements the WTRU makes on the received PRS(s). In an example, the WTRU may apply the received correction information to the measurements and report corrected measurements to the network. In another example, the WTRU may apply the received correction information to the measurements and use corrected measurements to derive (or compute) inference values or inference information associated with positioning methods or PRS configurations. In an example, the WTRU may use corrected measurements to derive or compute its own location. In another example, the WTRU may determine a positioning method based on correction information (e.g., received from the network). For example, the WTRU may determine to use a differential positioning method (e.g., differential timing positioning method, differential DL-TDOA) if correction information (e.g., timing offset) is above and/or equal to a preconfigured threshold. If correction information is below the preconfigured threshold, the WTRU may determine to apply the correction information to the measurements and use a non-differential method (e.g., DL-TDOA).

Definition of correction information. The WTRU may receive correction information from the network via RRC signaling, an LPP message, a broadcast message, a unicast message, MAC-CE, DCI, or a groupcast message. The WTRU may receive correction information in a broadcast message (e.g., from the network, a node, or another WTRU). Alternatively, the WTRU may receive WTRU-specific correction information. In an example, the WTRU-specific correction information may contain at least one of the following:
Phase offset,
Timing offset,
Angle offset, and/or
Power offset.

The examples of correction information may be a specific value, a range of values, and/or statistical characteristics (e.g., mean of timing offset, standard deviation or variance of timing offset). For example, the WTRU may receive from the network a timing offset the WTRU applies to measurements. In another example, the WTRU may receive (e.g., from the network) a range of timing offsets. The WTRU may determine a value from the range of timing offsets to apply to measurements. The WTRU may determine the value based on measurements made on PRS resources. For example, if RSTD is below a preconfigured threshold, the WTRU may determine (or select) to use lower limit of the configured range for correction information. If RSTD is above and/or equal to a preconfigured threshold, the WTRU may determine to use upper limit of the configured range for correction information.

In an example, the WTRU may be preconfigured with a list of correction information (e.g., a list of timing offsets, a list of ranges of timing offsets) with associated identifications (IDs). For example, if the list includes timing offsets with associated ID(s), each row in the list (e.g., a table, or an index) may contain an ID and associated timing offset. Alternatively, if the list includes ranges of timing offset, each row in the list (e.g., a table, or an index) may contain an ID and associated ranges of timing offsets. The WTRU may receive an ID from the network, indicating which correction information from the preconfigured list of correction information to use. The WTRU may receive the preconfigured list of correction information from the network (e.g., LMF, gNB).

In another example, the WTRU may receive configuration information (e.g., via an indication) related to a function the WTRU may use to derive correction information. The WTRU may receive parameters (e.g., an antenna reference point, power difference between PRS resources, number of paths in a transmission/channel, expected RSTD) related to the function from the network which the WTRU uses to derive correction information. In one example, the WTRU may receive area-dependent correction information. For example, the WTRU may receive a preconfigured table of correction information from the network where each row in the table corresponds to correction information with corresponding ID. The ID may correspond to an area identification (e.g., cell ID, global cell ID). In some cases, the WTRU may determine which correction information to apply depending on the cell the WTRU belongs to.

Correction information and WTRU capability. Types of correction information the WTRU receive may depend on WTRU capability. For example, the WTRU may only be capable of processing (e.g., applying correction information to measurements) ranges of timing offsets. In some cases, the WTRU may be capable of processing a specific value of timing offset or a specific set of values (of timing offsets).

Association information. In various embodiments, correction information, or a preconfigured list or table of correction information, or each respective correction information, may be associated with a group or set of PRS resources or SRS resources. Alternatively, the WTRU may receive correction information that is associated with a (e.g., specific) PRS resource or SRS resource. The WTRU may receive association information from the network in the aforementioned message format. In an example, the WTRU may receive correction information from the network, indicating that T ms of correction or timing offset should be applied to measurements made using PRS resource #1. The WTRU may receive, from the network, information associating a group ID (e.g., Timing error group) and PRS resource IDs. The WTRU may receive correction information associated with the group ID. For example, the WTRU may receive correction information which indicates that the T′ ms of correction or timing offset should be applied to PRS resources associated with TEG ID #1. Based on the received correction information, the WTRU may determine to apply correction information to measurements made with the associated PRS resources. The WTRU may receive correction information along with information related to the distributor of correction information (e.g., a TRP ID, a PRS ID, a cell ID, a gNB ID, or a global cell ID).

Conditions that the WTRU receives correction information. The WTRU may receive correction information based on positioning methods the WTRU is configured with. For example, the WTRU may receive correction information related to timing when the WTRU applies timing-based positioning methods (e.g., DL-TDOA, UL-TDOA, and/or multi-RTT). The WTRU may receive correction information when the WTRU uses WTRU-assisted or WTRU-based positioning method. In WTRU-assisted positioning methods, the WTRU may return measurement reports to the network. On the other hand, in WTRU-based positioning methods, WTRU may determine its own location information or position based on the measurements the WTRU make on PRS resources. In an example, the correction information may be associated with one or more validity conditions. For example, the validity conditions may be related to time (e.g. start time, time duration, end time) and/or area (e.g., set of one or more cell IDs) where the correction information may be considered to be valid for usage with the associated positioning methods. In an example, the validity conditions associated with correction information may be the same or different as compared to the validity conditions associated with the assistance data related to the positioning methods. The WTRU may use the correction information on the positioning related measurements as long as the criteria associated with the validity conditions is met (e.g., correction information is valid within the validity time duration and/or validity area). The WTRU may send a request to network, possibly for updating and/or receiving new correction information, upon detecting the expiry of one or more validity conditions, for example.

Periodicity of distribution of correction information. The WTRU may receive correction information at configured periodicity or configured duration. For example, the WTRU may receive periodicity of transmission of correction information from the network. The WTRU may receive duration (e.g., start time, time duration, and/or end time) of transmission of correction information from the network. The WTRU may receive configurations related to duration, periodicity and/or start/end time of transmission of correction information from the network. Alternatively or optionally, the WTRU may receive correction information from the network based on conditions. Examples of conditions may be changes in correction information, changes in association information between correction information between PRS resource(s) and correction information or based on a request from the WTRU for correction information.

Correction information associated with different level of configuration hierarchy. Correction information may be associated with a different granularity of PRS configuration. For example, the WTRU may receive correction information associated with a PRS frequency layer(s), PRS ID(s), TRP(s), PRS resource set(s) or PRS resource(s). For example if correction information (e.g., timing offset, power offset) is associated with a PRS frequency layer ID, the WTRU may apply the indicated corrections to measurements made with PRS resources which are associated with the PRS frequency layer ID. In another example, if correction information is associated with a PRS resource set, the WTRU may apply correction information to PRS resources associated with the PRS resource set.

Combination of correction information. In one embodiment, the WTRU may receive a combination of timing, angle, power and/or phase correction information associated with a group/set of PRS resources or SRS resources. Alternatively, the WTRU may receive correction information that is associated with a PRS resource or SRS resource.

Association of correction information with PRU. The WTRU may receive correction information associated with WTRU or PRU (Positioning reference unit) ID and/or their location information. The WTRU may determine to apply correction information based on WTRU or PRU information. For example, if the WTRU determines that the PRU is located close to the WTRU, e.g., below and/or equal to a preconfigured threshold, the WTRU may determine to apply the correction information to the measurements made with the associated PRS resources. The WTRU may receive the threshold from the network (e.g., LMF, gNB).

Trigger to receive correction information. The WTRU may receive broadcast information based on a request sent by the WTRU. For example, the WTRU may receive association between a TEG ID(s) and PRS resources from the network. Subsequently, the WTRU may send a request to the network to send correction information associated with the TEG ID(s). The WTRU may receive (e.g., from the network) correction information associated with group/TEG ID along with association between a TEG/group ID and group of PRS resources.

Actions of the WTRU after reception of correction information. If the WTRU receives correction information from the network, the WTRU may determine to apply correction information to the measurements and report the measurements to the network or process them to determine its location. If the WTRU does not receive correction information from the network (e.g., correction information may not be found in assistance information, correction information may be found to be invalid, request for correction information is rejected by the network, the WTRU may receive a message from the network that the network cannot provide correction information), the WTRU may determine to perform a positioning method (e.g., differential timing/angle positioning method). In an example, the WTRU may use a second positioning method when the correction information associated with a first positioning method is not received or available. The WTRU may receive a message via RRC signaling, an LPP message, MAC-CE, or DCI, from the network that indicates correction information may or may not be provided by the network. Based on the message, the WTRU may determine whether to use a positioning method that does not rely on correction information (i.e., differential timing positioning method).

### Conclusion

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer readable medium for execution by a computer or processor. Examples of non-transitory computer-readable storage media include, but are not limited to, a read only memory (ROM), random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU 102, WTRU, terminal, base station, RNC, or any host computer.

Moreover, in the embodiments described above, processing platforms, computing systems, controllers, and other devices containing processors are noted. These devices may contain at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the exemplary embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (“RAM”)) or non-volatile (e.g., Read-Only Memory (“ROM”)) mass storage system readable by the CPU. The computer readable medium may include cooperating or interconnected computer readable medium, which exist exclusively on the processing system or are distributed among multiple interconnected processing systems that may be local or remote to the processing system. It is understood that the representative embodiments are not limited to the above-mentioned memories and that other platforms and memories may support the described methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost vs. efficiency tradeoffs. There may be various vehicles by which processes and/or systems and/or other technologies described herein may be affected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

It is also to be understood that the terminology used herein is for the purpose of describing particular embodiments only, and is not intended to be limiting. As used herein, when referred to herein, the terms “station” and its abbreviation “STA”, “user equipment” and its abbreviation “UE” may mean (i) a wireless transmit and/or receive unit (WTRU), such as described infra; (ii) any of a number of embodiments of a WTRU, such as described infra; (iii) a wireless-capable and/or wired-capable (e.g., tetherable) device configured with, inter alia, some or all structures and functionality of a WTRU, such as described infra; (iii) a wireless-capable and/or wired-capable device configured with less than all structures and functionality of a WTRU, such as described infra; or (iv) the like. Details of an example WTRU, which may be representative of any WTRU recited herein, are provided below with respect to FIGS. 1A-1D.

In certain representative embodiments, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

The herein described subject matter sometimes illustrates different components contained within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” or “group” is intended to include any number of items, including zero. Additionally, as used herein, the term “number” is intended to include any number, including zero.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

Although the invention is illustrated and described herein with reference to specific embodiments, the invention is not intended to be limited to the details shown. Rather, various modifications may be made in the details within the scope and range of equivalents of the claims and without departing from the invention.

Throughout the disclosure, one of skill understands that certain representative embodiments may be used in the alternative or in combination with other representative embodiments.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer readable medium for execution by a computer or processor. Examples of non-transitory computer-readable storage media include, but are not limited to, a read only memory (ROM), random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a UE, WTRU, terminal, base station, RNC, or any host computer.

Moreover, in the embodiments described above, processing platforms, computing systems, controllers, and other devices containing processors are noted. These devices may contain at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits.

The data bits may also be maintained on a computer readable medium including magnetic disks, optical disks, and any other volatile (e.g., Random Access Memory (“RAM”)) or non-volatile (“e.g., Read-Only Memory (“ROM”)) mass storage system readable by the CPU. The computer readable medium may include cooperating or interconnected computer readable medium, which exist exclusively on the processing system or are distributed among multiple interconnected processing systems that may be local or remote to the processing system. It is understood that the representative embodiments are not limited to the above-mentioned memories and that other platforms and memories may support the described methods.

No element, act, or instruction used in the description of the present application should be construed as critical or essential to the invention unless explicitly described as such. In addition, as used herein, the article “a” is intended to include one or more items. Where only one item is intended, the term “one” or similar language is used. Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Further, as used herein, the term “set” is intended to include any number of items, including zero. Further, as used herein, the term “number” is intended to include any number, including zero.

Moreover, the claims should not be read as limited to the described order or elements unless stated to that effect. In addition, use of the term “means” in any claim is intended to invoke 35 U.S.C. § 112, ¶6, and any claim without the word “means” is not so intended.

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, Mobility Management Entity (MME) or Evolved Packet Core (EPC), or any host computer. The WTRU may be used m conjunction with modules, implemented in hardware and/or software including a Software Defined Radio (SDR), and other components such as a camera, a video camera module, a videophone, a speakerphone, a vibration device, a speaker, a microphone, a television transceiver, a hands free headset, a keyboard, a Bluetooth® module, a frequency modulated (FM) radio unit, a Near Field Communication (NFC) Module, a liquid crystal display (LCD) display unit, an organic light-emitting diode (OLED) display unit, a digital music player, a media player, a video game player module, an Internet browser, and/or any Wireless Local Area Network (WLAN) or Ultra Wide Band (UWB) module.

Although the invention has been described in terms of communication systems, it is contemplated that the systems may be implemented in software on microprocessors/general purpose computers (not shown). In certain embodiments, one or more of the functions of the various components may be implemented in software that controls a general-purpose computer.

In addition, although the invention is illustrated and described herein with reference to specific embodiments, the invention is not intended to be limited to the details shown. Rather, various modifications may be made in the details within the scope and range of equivalents of the claims and without departing from the invention.

1. A method implemented by a wireless transmit/receive unit (WTRU) for wireless communications, the method comprising:
receiving configuration information for determining a combination of a plurality of positioning methods, wherein the configuration information indicates 1) using and reporting weights for the plurality of positioning methods and 2) a threshold for weight comparison;
determining a respective weight for each respective positioning method of the plurality of positioning methods; and
sending the respective weights for the plurality of positioning methods based on at least one of the respective weights being greater than the threshold.

2. The method of claim 1, wherein the respective weights for the plurality of positioning methods are sent after a preconfigured time period.

3. The method of claim 1, wherein the configuration information indicates information of a reference point for positioning.

4. The method of claim 3, further comprising:
determining a positioning estimate for the reference point; and
determining a respective positioning estimate for each respective positioning method of the plurality of positioning methods.

5. The method of claim 4, wherein the respective weight for each respective positioning method is determined based on 1) the respective positioning estimate for each respective positioning method and 2) the positioning estimate for the reference point.

6. The method of claim 1, wherein a sum of the respective weights for the plurality of positioning methods equals to one.

7. The method of claim 1, further comprising:
determining that the respective weight is a highest weight among the respective weights for the plurality of positioning methods, and
sending a request message to reconfigure a positioning reference signal (PRS) associated with the respective positioning method.

8. The method of claim 7, further comprising:
receiving information indicating a positioning reference signal (PRS) reconfiguration; and
measuring one or more PRSs based on the PRS reconfiguration.

9. The method of claim 1, further comprising:
receiving information for measuring a set of positioning reference signals (PRSs); and
measuring one or more received PRSs of the set of PRSs based on the information.

10. The method of claim 1, further comprising:
transmitting a request to a network to perform machine learning (ML)-based training of a procedure for performing geographic positioning of the WTRU;
receiving a Positioning Reference Signal (PRS) configuration from the network;
training a positioning method for performing positioning in the network based on the received PRS configuration using a ML-based training technique and/or AI-based technique; and
performing positioning functions using the developed positioning method.

11-26. (canceled)

27. A wireless transmit/receive unit (WTRU) for wireless communications, the WTRU comprising circuitry, including a processor, a transmitter, a receiver, and memory, configured to:
receive configuration information for determining a combination of a plurality of positioning methods, wherein the configuration information indicates 1) using and reporting weights for the plurality of positioning methods and 2) a threshold for weight comparison;
determine a respective weight for each respective positioning method of the plurality of positioning methods; and
send the respective weights for the plurality of positioning methods based on at least one of the respective weights being greater than the threshold.

28. The WTRU of claim 27, wherein the WTRU is further configured to send the respective weights for the plurality of positioning methods after a preconfigured time period.

29. The WTRU of claim 27, wherein the configuration information indicates information of a reference point for positioning.

30. The WTRU of claim 29, wherein the WTRU is further configured to:
determine a positioning estimate for the reference point; and
determine a respective positioning estimate for each respective positioning method of the plurality of positioning methods.

31. The WTRU of claim 30, wherein the respective weight for each respective positioning method is determined based on 1) the respective positioning estimate for each respective positioning method and 2) the positioning estimate for the reference point.

32. The WTRU of claim 27, wherein a sum of the respective weights for the plurality of positioning methods equals to one.

33. The WTRU of claim 27, wherein the WTRU is further configured to:
determine that the respective weight is a highest weight among the respective weights for the plurality of positioning methods, and
send a request message to reconfigure a positioning reference signal (PRS) associated with the respective positioning method.

34. The WTRU of claim 27, wherein the WTRU is further configured to:
receive information indicating a positioning reference signal (PRS) reconfiguration; and
measure one or more PRSs based on the PRS reconfiguration.

35. The WTRU of claim 27, wherein the WTRU is further configured to:
receive information for measuring a set of positioning reference signals (PRSs); and
measure one or more received PRSs of the set of PRSs based on the information.

36. The WTRU of claim 27, wherein the WTRU is further configured to:
transmit a request to a network to perform machine learning (ML)-based training of a procedure for performing geographic positioning of the WTRU;
receive a Positioning Reference Signal (PRS) configuration from the network;
train a positioning method for performing positioning in the network based on the received PRS configuration using a ML-based training technique and/or AI-based technique; and
perform positioning functions using the developed positioning method.
